(19) United States
(12) Patent Application Publication
(10) Pub. No.: US 2007/0257986 A1
(43) Pub. Date: Nov. 8, 2007

(54) Method for processing queries for surveillance tasks

(76) Inventors: Yuri A. Ivanov, Cambridge, MA (US); Christopher R. Wren, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/429,024

(22) Filed: May 5, 2006

(51) Int. Cl. H04N 7/18

(52) U.S. Cl. 348/154

(57) ABSTRACT

A method for querying a surveillance database stores videos and events acquired by cameras and detectors in an environment. Each event includes a time at which the event was detected. The videos are indexed according to the events. A query specifies a spatial and temporal context. The database is searched for events that match the spatial and temporal context of the query, and only segment of the videos that correlate with the matching events are displayed.

### FIELD OF THE INVENTION

This invention relates generally to surveillance systems, and more particularly to querying and visualizing surveillance data.

### BACKGROUND OF THE INVENTION

Surveillance and sensor systems are used to make environments safer and more efficient. Typically, surveillance systems detect events in signals acquired from an environment. The events can be due to people, vehicles, or changes in the environment itself. The signals can be complex, for example, visual (video) and acoustic, or the signals can be simple from sensors such as from heat sensors and motion detectors.

The detecting can be done in real-time as the events occur, or off-line after the events have occurred. The off-line processing requires means for storing, searching, and retrieving recorded events. It is desired to automate the processing of surveillance data.

A number of systems for analyzing surveillance videos are known, Stauffer, et al., “Learning patterns of activity using real-time tracking,” IEEE Transactions on Pattern Recognition and Machine Intelligence, 22(8):747-757, 2000, Yuri A. Ivanov and Aaron F. Bobick, Recognition of Visual Activities and Interactions by Stochastic Parsing, Transactions on Pattern Analysis and Machine Intelligence 22(8): 852-872, 2000, Johnson, et al., “Learning the distribution of object trajectories for event recognition,” Image and Vision Computing, 14(8), 1996, Minnen, et al., “Expectation grammars: Leveraging high-level expectations for activity recognition,” Workshop on Event Mining, Event Detection, and Recognition in Video, Computer Vision and Pattern Recognition, volume 2, page 626, IEEE, 2003, Cutler, et al., “Real-time periodic motion detection, analysis and applications,” Conference on Computer and Pattern Recognition, pages 326-331, Fort Collins, USA, 1999. IEEE, and Moeslund, et al., “A survey of computer vision based human motion capture,” Computer Vision and Image Understanding, 81:231-268, 2001.

Several systems use gestural input to improve usability of computer systems, R. A. Bolt. ‘put-that-there’: Voice and gesture at the graphics interface. Computer Graphics Proceedings, SIGGRAPH 1980, 14(3):262-70, July 1980, Christoph Maggioni. Gesturecomputer—new ways of operating a computer. SIEMENS AG Central Research and Development, 1994, David McNeill. Hand and Mind: What Gestures Reveal about Thought. The University of Chicago Press, 1992.

### SUMMARY OF THE INVENTION

The embodiments of the invention provide a system and method for detecting unusual events in an environment, and for searching surveillance data using a global context of the environment. The system includes a network of heterogeneous sensors, including motion detectors and video cameras. The system also includes a surveillance database for storing the surveillance data. A user specifies queries that take advantage of a spatial context of the environment.

Specifically, a method for querying a surveillance database stores videos and events acquired by cameras and detectors in an environment. Each event includes a time at which the event was detected. The videos are indexed according to the events. A query specifies a spatial and temporal context. The database is searched for events that match the spatial and temporal context of the query, and only segments of the videos that correlate with the matching events are displayed.

### BRIEF DESCRIPTION OF THE DRAWINGS

FIG. 1A is a block diagram of a surveillance system according to an embodiment of the invention;

FIG. 1B is a block diagram of an environment; and

FIGS. 2-10 are images displayed by the system of FIG. 1 on a display device according to embodiments of the invention.

### DETAILED DESCRIPTION OF THE PREFERRED EMBODIMENT

System

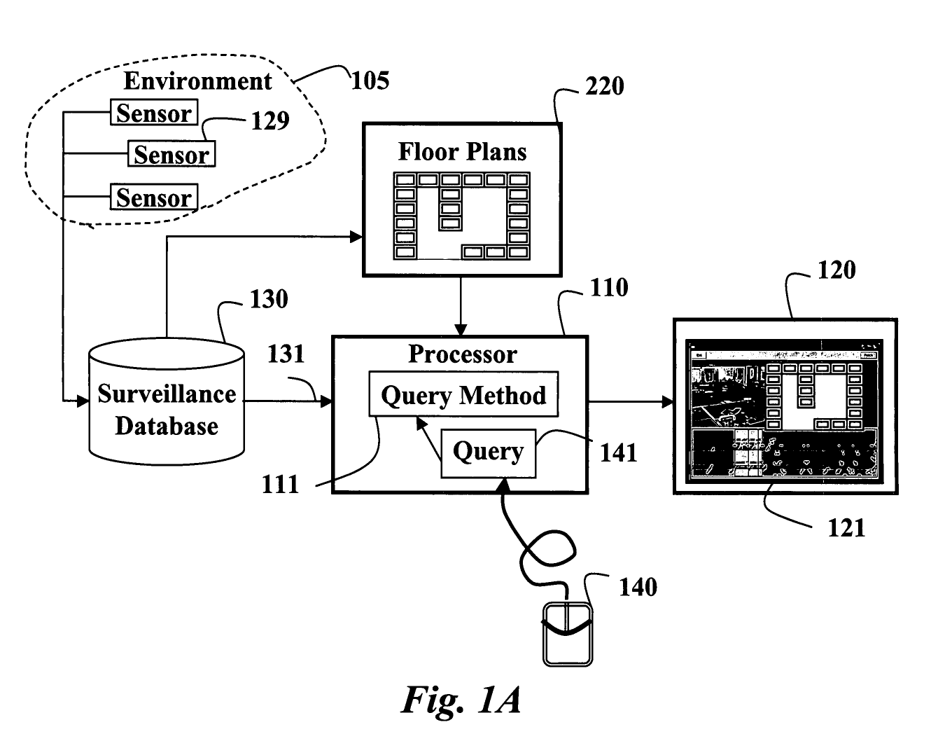

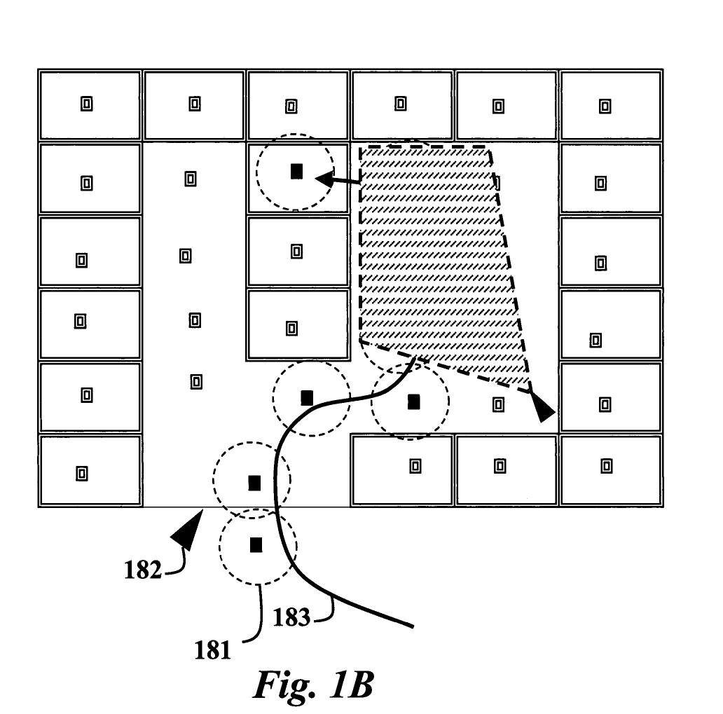

FIG. 1 shows a system and method for performing a query on surveillance data according to an embodiment of our invention. The system includes a processor 110, a display device 120 and a surveillance database connected to each other 130. It should be noted that multiple display devices can be used to monitor more than one location at the time.

The processor is conventional and includes memory, buses, and I/O interfaces. The processor can perform the query method 111 according to an embodiment of the invention. The surveillance database stores surveillance data, e.g., video and sensor data streams 131, and plans 220 of an environment 105 where the surveillance data are collected.

An input device 140, e.g., a mouse or touch sensitive surface can be used to specify a spatial query 141. Results 121 of the query 141 are displayed on the display device 120.

Sensors

The sensor data 131 are acquired by a network of heterogeneous sensors 129. The sensors 129 can include video cameras and detectors. Other types of sensors as known in the art can also be included. Because of the relative cost of the cameras and the detectors, the number of detectors may be substantially larger than the number of cameras; i.e., the cameras are sparse and the detectors are dense in the environment. For example, one area viewed by one camera can include dozens of detectors. In a large building, there could be hundreds of cameras, but thousands and thousands of detectors. Even though the number of detectors can be relatively large compared with the number of cameras, the amount of data (events/times) acquired by the detectors is miniscule compared with the video data. Therefore, the embodiments of the invention leverage the event data to rapidly locate video segments of potential interest.

The plan 220 can show the location of the sensors. A particular subset of sensors can be selected by the user using the input device, or by indicating a general area on the floor plan.

Sensors

The set of sensors in the system consists of regular surveillance video cameras and various detectors, implemented in either hardware or software. Usually, the cameras continuously acquire videos of areas of the environment. Typically cameras do not respond to activities in their field of view, but simply record the images of the monitored environment. It should be noted, that the videos can be analyzed using conventional computer techniques. This can be done in real-time, or after the videos are acquired. The computer vision techniques can include object detection, object tracking, object recognition, face detection, and face recognition. For example, the system can determine whether a person entered a particular area in the environment, and record this as a time stamped event in the database.

Other detectors, e.g., motion detectors and other similar detectors, may be either active or passive as long as they signal discrete time-stamped events. For example, a proximity detector signals in response to a person moving near the detector at a particular instant in time.

Queries 141 on the databases 130 differ from conventional queries on typical multimedia databases in that the surveillance data share a spatial and temporal context. We leverage this shared context explicitly in a visualization of the query results 121, as well as in a user interface used to input the queries.

Display Interface

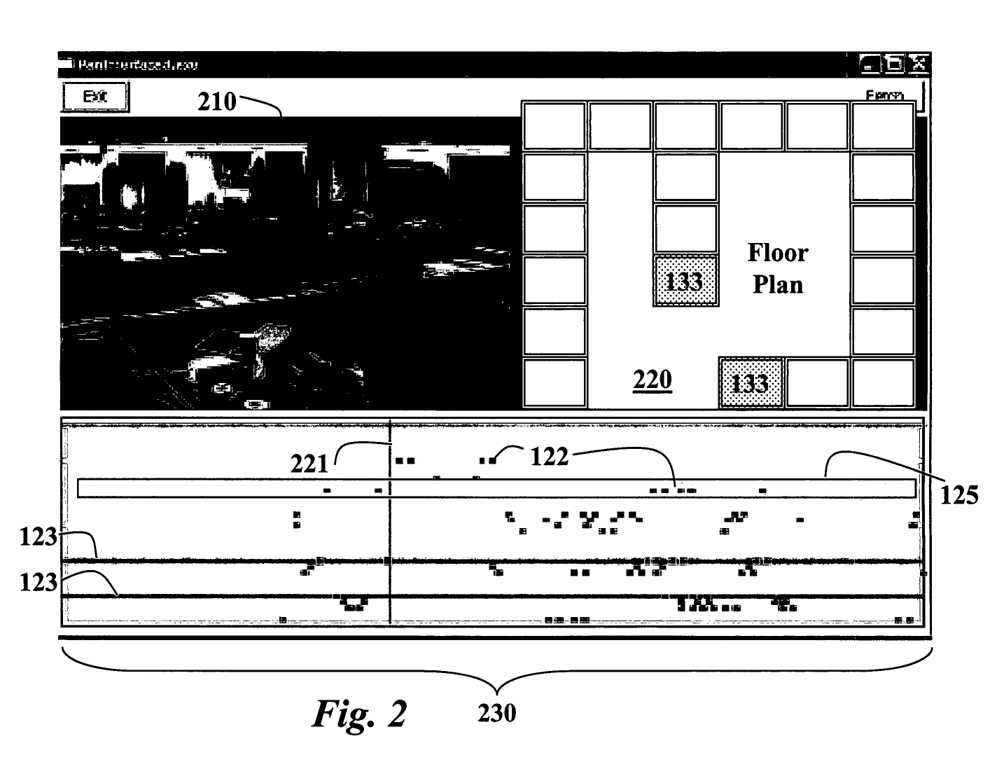

As shown in FIG. 2, the display interface 120 that includes a video playback window 210 at the upper left, a floor plan window 220 at the upper right, and an event time line window 230 along a bottom portion of the screen. The video playback window 210 can present video streams from any number of cameras. The selected video can correspond to an activation zone 133.

The event timeline 230 shows the events in a “player piano roll” format, with time running from left to right. A current time is marked by a vertical line 221. The events for the various detectors are arranged along the vertical axis. The rectangles 122 represent events (vertical position) being active for a time (horizontal position and extent). We call each horizontal arrangement for a particular sensor an event track, as outlined by a rectangular block 125 only for the purpose of this description.

The visualization has a common highlighting scheme. The activation zones 133 can be highlighted with color on the floor plan 220. Sensors that correspond to the activation zones are indicated on the event timeline by horizontal bars 123 rendered in the same color. A video can be played that corresponds to events, at a particular time, and a particular area of the environment.

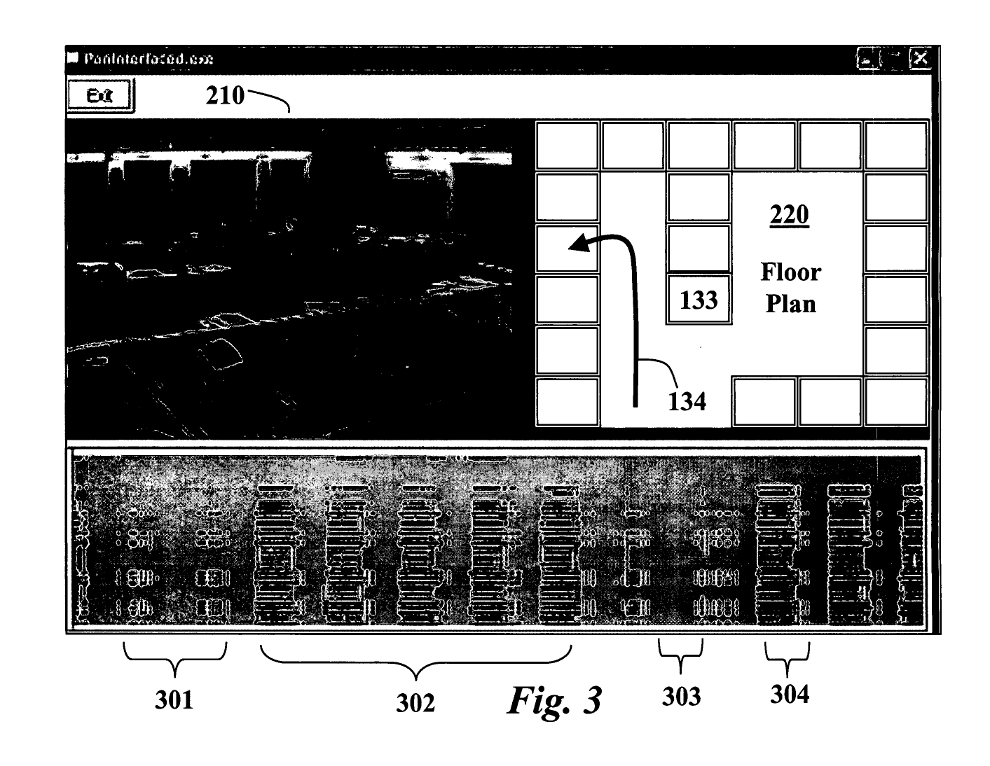

FIG. 3 shows the interface with the event timeline 230 over an extended period of time, for example two weeks. It is obvious the two days of a relatively small number of events 301 are followed by five days of a large number of events 302. The day 304 and night 303 patterns are also clearly visible as dense and sparse bands of events.

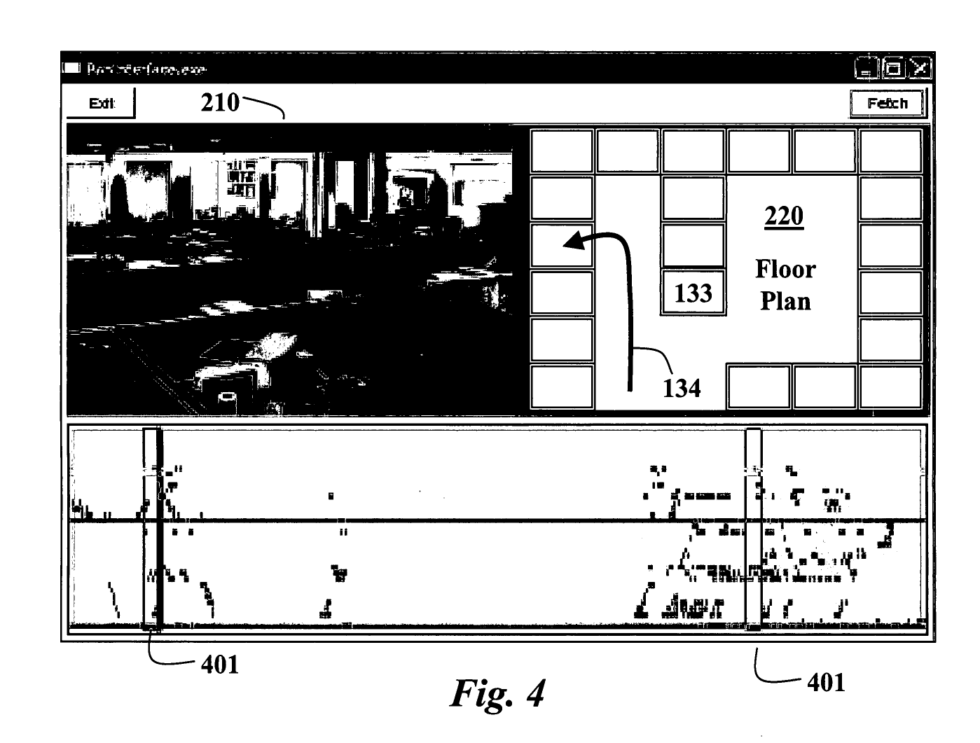

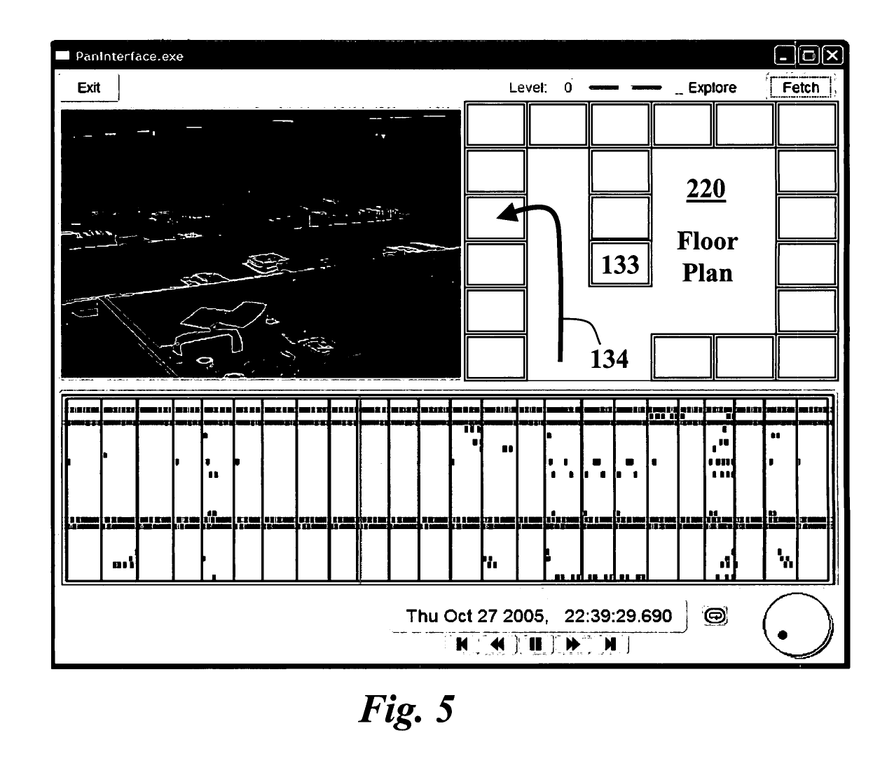

After events have been located in the database 130, the events can be displayed either on the background of the complete timeline (see FIG. 4), or side-to-side, as shown in FIG. 5, such that a continuous playback only displays the results of the queries.

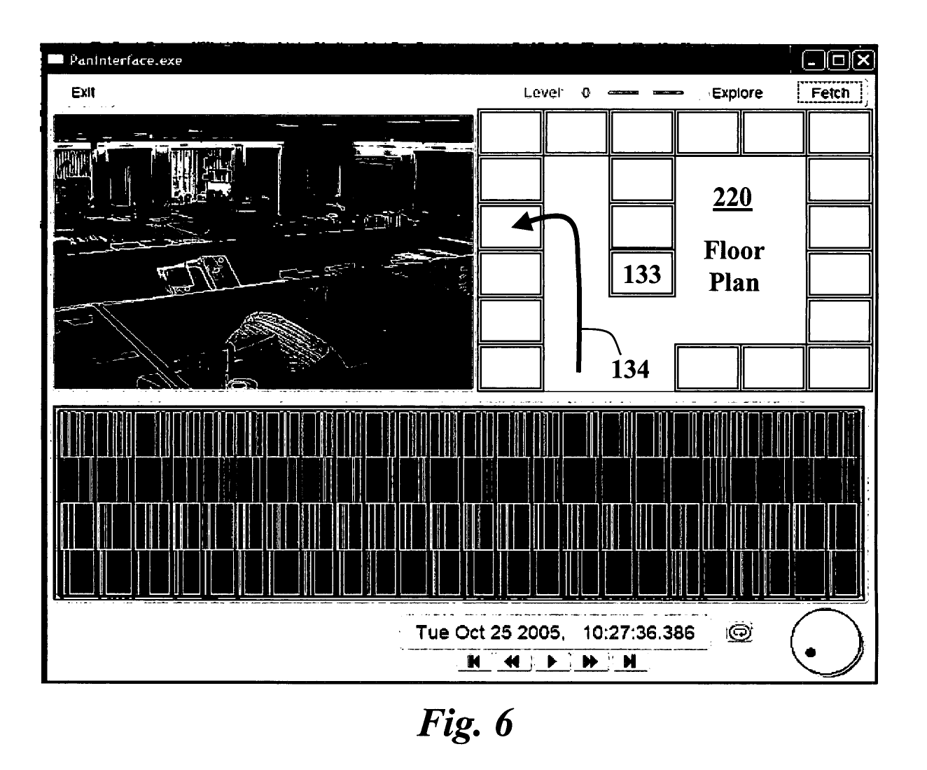

The event time line can be further compressed by removing tracks of all sensors not related to a query, as shown in FIG. 6. The figure represents exactly the same result set as shown in FIG. 5, but with the tracks for all irrelevant sensors removed from the display.

Selection and Queries

A simple query can simply request all the video segments that include any type of motion. Generally, this query returns too much information. A better query specifies an activation zone 133 on the floor plan 220. The zone can be indicated with the mouse 140, or if a touch-sensitive screen is used, by touching the plan 220 at the appropriate location(s).

In a still better query specifies context constraints in the form of a path 134 and an event timing sequence. The system automatically joins these context constraints with the surveillance data, and the results are appropriately refined for display. Because the system has access to the database of events, the system can analyze the event data for statistics, such as inter-arrival times.

Paths

According to one embodiment the detected events can be linked in space and time to form a path and an event timing sequence. For example, a person walking down a hallway will cause a linear subset of the detectors mounted in the ceiling to signal events serially at predictable time intervals that are consistent with walking. For example, if the detectors are spaced apart by about 5 meters, the detectors will signal events serially at times separated by about two to three second. In this event timing sequence the events are well separated. The event timing sequence caused by a running person can also easily be distinguished in that spatially adjacent detectors will signal events at almost the same time.

FIG. 1B shows an example environment. The location of detectors 181 are indicated by rectangles. The dashed lines approximately indicate the range of the sensors. The system selects sensors whose range intersects the path for the purpose of a query. The locations of cameras are indicated by triangles 182. A user can specify a path 183 that a person would follow to move from an entryway to a particular office. By selecting a corresponding subset of the detectors (filled rectangles), and relative times at which the sensors were activated, e.g., the detectors signal events having an event timing sequence consistent with running. The database 130 can be searched to detect if there ever was a running person moving along that specific path. If such an event occurred, the system can playback the video that corresponds to the event.

The amount of data associated with sensor events is substantially smaller that the amount of data associated with videos. In addition, the events and their times can be efficiently organized in a data structure. If the times in the video and the times of the events are correlated in the database, than it is possible to search the database with a spatio-temporal query to quickly locate video segment that correspond to unusual events in the environment.

Similarly, video segments can be used to search the database where events of interest can include a particular feature observation in the camera view (video). For instance, we can search for trajectories that a particular person traversed in a monitored area. This can be done by detecting and identifying faces in the videos. If such face data and discrete event data are stored in the database, then all detected faces can be presented to the user, a user can select a particular face, and the system can use the temporal and spatial information about that particular face to perform a search in the database to determine where in the monitored area that person has attended.

FIG. 4 shows the result of a query as described above. On the event timeline, vertical highlight bars 401 indicate the events and time intervals that are involved in the query.

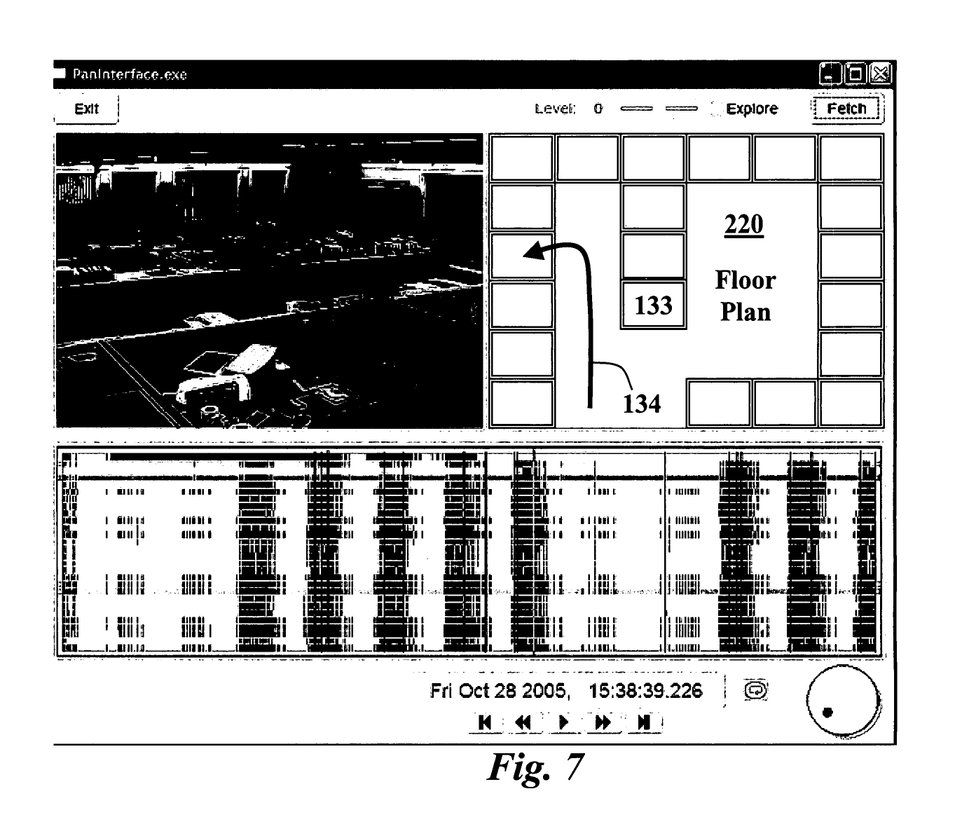

FIG. 7 shows an example of the query where the temporal constraints are strictly enforced, such that a sequence of sensor activations is identified by the system as being valid only if the specified subset of sensors signal events serially within predetermined time intervals of each other.

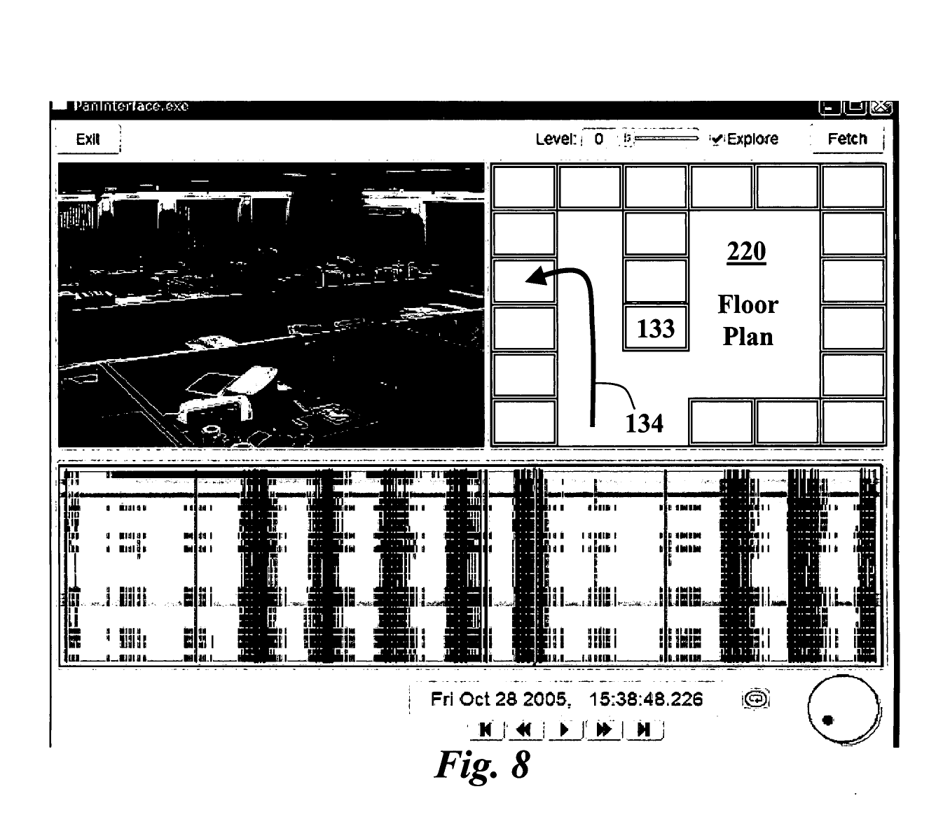

FIG. 8 shows the same query as for FIG. 7, but with the query timing constraints relaxed and allowed to vary with respect to a common reference point, and not to its immediate predecessor. That is, if the event sequence consists of three motion detectors signaling serially within one second from an immediate predecessor, then FIG. 7 shows the results of such a constrained query, where the event signaled by the third detector is only accepted as a valid search result if the third detector signaled an event within one seconds after detector 2 stopped signaling.

A less constrained query identifies a sequence as valid result if the second detector activates within one second from the first and the third detector within two to three seconds from the first detector, regardless of the signaling of the second detector. FIG. 8 shows the results of such a less constrained query.

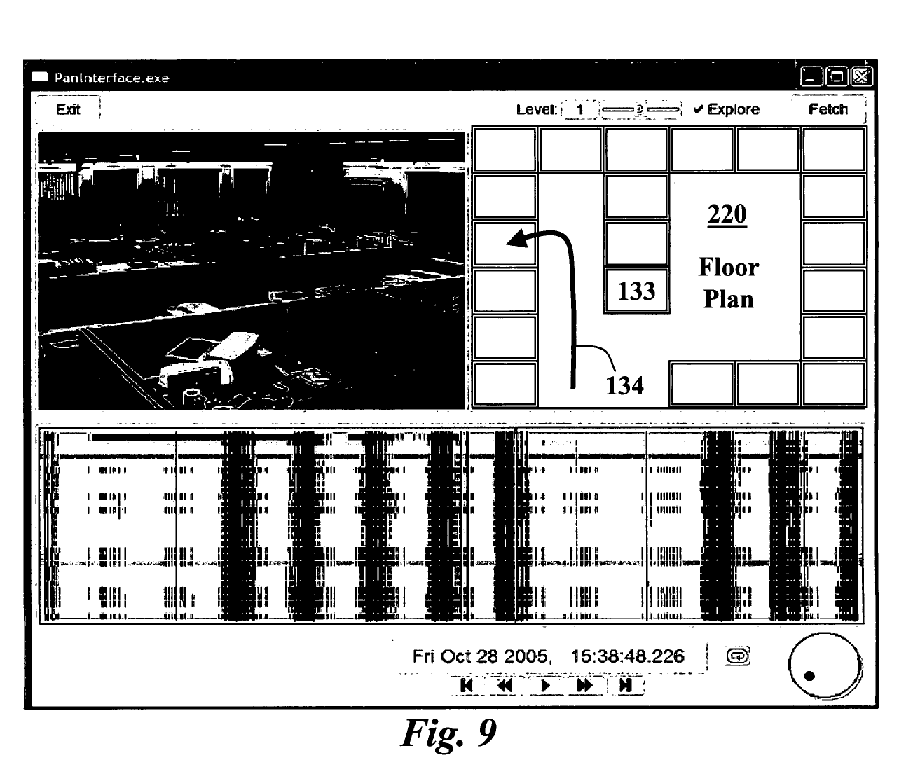

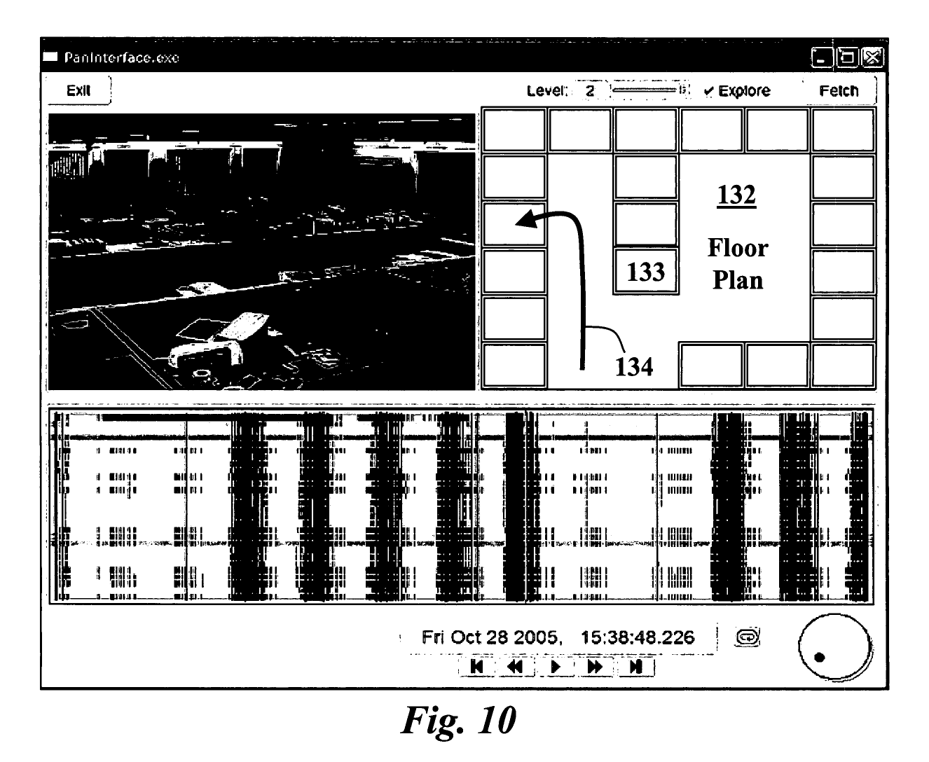

The system has various levels of search constraints: level 0, level 1, level 2, etc, that can be assigned to the query. FIGS. 8-10 show the display of results of the same query with Level 0-2 constraints, respectively. In a level 0 constraint, all sensors along a particular path and in an event timing sequence must signal for the sensor event sequence to be reported as shown in FIG. 8. In a level 1 constraint, a single sensor is allowed to be inactive as shown in FIG. 9. In a level 2 constraint, up to two sensors in the path can be inactive for the query to be reported as shown in FIG. 10.

A strict query only searches for events that exactly match the query, and a less constrained query admits variations. For example, a query specifies that sensors 1-2-3-4 should signal in order. Level 0 finds all event chains where sensors 1-2-3-4 signaled. Level 1 in addition to that also finds sequences 1-3-4, and 1-2-4, where the timings of sensors that did signal satisfy the constraints. Then, Level 2 allows any two sensors to be inactive, and thus finds all instances of sensors 1-4 where timings of sensor 1 and sensor 4 are satisfied. As the level number gets larger, there are more and more search results for a given query.

For any query involving N sensors, N levels of constraints are generally available.

Effect of the Invention

The system and method as described above can locate events that are not fully detected by any one sensor, be that camera or a particular motion detector. This enables a user of the system to treat all sensor in an environment as one ‘global’ sensor, instead of a collection of independent sensors.

For example, it is desired to locate events that are consistent with an unauthorized intrusion. A large amount of the available video can be eliminated by rejecting video segments that are not correlated to sensor event sequences that are inconsistent with the intrusion, and only providing the user with video segments are consistent with the intrusion.

It is to be understood that various other adaptations and modifications may be made within the spirit and scope of the invention. Therefore, it is the object of the appended claims to cover all such variations and modifications as come within the true spirit and scope of the invention.

We claim:

1. A method for querying a surveillance database, comprising:
storing in a surveillance database videos and events, the videos acquired by cameras in an environment, and the events signaled by detectors in the environment, each event including a time at which the event was detected;
indexing the videos according to the events;
specifying a query including a spatial and temporal context;
searching the database for events that match the spatial and temporal context of the query; and
displaying only segment of the videos that correlate with the events.

2. The method of claim 1, in which the specifying of the spatial context comprises selecting an area of the environment, the selected area associated with a subset of the detectors and cameras, and the specifying of the temporal context comprises specifying an event timing sequence for the events.

3. The method of claim 1 in which the database stores a plan of the environment, and further comprising:
displaying the plan while specifying and displaying.

4. The method of claim 1, in which the detectors are motion detectors.

5. The method of claim 3, in which the plan includes locations of the detectors.

6. The method of claim 3, in which the specifying of the spatial context uses the plan.

7. The method of claim 1, further comprising:
time stamping the events.

8. The method of claim 1, in which the events include events detected in the videos.

9. The method of claim 8, in which the events in the video are detected using computer vision techniques.

10. The method of claim 1, in which a display interface includes a video playback window, a floor pan window, and an event time line window.

11. The method of claim 1, in which the spatial context defines a spatial ordering and a temporal ordering of the events.

12. The method of claim 1, in which the spatial ordering and the temporal ordering correspond to an object moving in the environment.

13. The method of claim 1, further comprising:
assigning a level of constraint to the query.

14. The method of claim 3, in which the plan is used for displaying the events and for specifying the query.
